(19) United States
(12) Patent Application Publication
(10) Pub. No.: US 2009/0247203 A1
(43) Pub. Date: Oct. 1, 2009

(54) Method and Apparatus for Improving DRX Functionality

(76) Inventor: Richard Lee-Chee Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/410,474

(22) Filed: Mar. 25, 2009

Related U.S. Application Data
(60) Provisional application No. 61/039,108, filed on Mar. 25, 2008.

(51) Int. Cl. H04B 7/00

(52) U.S. Cl. 455/509

(57) ABSTRACT

A method for improving Discontinuous Reception (DRX) Functionality in a user equipment (UE) of a wireless communication system is disclosed. The method includes steps of receiving a Radio Resource Control (RRC) message, which contains a DRX Configuration Information Element (IE drx-Configuration), activating a DRX functionality according to the IE drx-Configuration, and starting monitor a Physical Downlink Control Channel (PDCCH) until a PDCCH signaling addressed to the UE is received.

### CROSS REFERENCE TO RELATED APPLICATIONS

This application claims the benefit of U.S. Provisional Application No. 61/039,108, filed on Mar. 25, 2008 and entitled “Method and Apparatus for Improving DRX Functionality in a Wireless Communication System”, the contents of which are incorporated herein by reference.

### BACKGROUND OF THE INVENTION

1. Field of the Invention

The present invention relates to a method and apparatus for improving Discontinuous Reception (DRX) functionality, and more particularly, to a method and apparatus for improving DRX Functionality in a user equipment (UE) of a wireless communication system to avoid transmission delay of an RRC procedure complete message.

2. Description of the Prior Art

Long Term Evolution wireless communication system (LTE system), an advanced high-speed wireless communication system established upon the 3G mobile telecommunication system, supports only packet-switched transmission, and tends to implement both Medium Access Control (MAC) layer and Radio Link Control (RLC) layer in one single communication site, such as in Node B (NB) alone rather than in NB and RNC (Radio Network Controller) respectively, so that the system structure becomes simple.

In LTE system, Discontinuous Reception (DRX) functionality is applied to the MAC layer for allowing a user equipment (UE) to enter a standby mode during certain periods of time and stopping monitoring a Physical Downlink Control Channel (PDCCH), so as to reduce power consumption of the UE.

If the DRX functionality is configured, whenever a new DRX cycle begins, an On Duration Timer is started and the UE is awaked to monitor the PDCCH until the On Duration Timer expires. In addition, when a DRX Inactivity Timer or a DRX Retransmission Timer is running, the UE also monitors the PDCCH to acquire information about whether the network has assigned resources for uplink transmission or whether the network has downlink data for the UE to receive.

In other words, when the DRX functionality is initiated, if both the DRX Inactivity Timer and the DRX Retransmission Timer are not started, the UE has to wait until the next On Dutation, during which the On Duration Timer is running, to have a chance to monitor the PDCCH, and thereby acquire an uplink grant assigned by the network or pefrom downlink data reception. Detailed operation of the DRX functionality can be found in related specifications, and is not narrated herein.

According to related specifications, an Information Element (IE) drx-Configuration, used for configuring the DRX functionality, is included in an RRC Connection Setup message, an RRC Connection Re-establishment message or an RRC Connection Reconfiguration for transmission. That is to say, the network is able to configure the DRX functionality through the above three messages. When any of the above three messages is received, the UE shall respond a RRC procedure complete message accordingly, such as an RRC Connection Setup Complete message, an RRC Connection Re-establishment Complete message or an RRC Connection Reconfiguration Complete message, to complete a related RRC procedure.

However, when the DRX functionality is initiated, the UE has to wait until the next On Dutation to have a chance to monitor the PDCCH, so that an uplink grant assigned by the network can be acquired for replying the RRC procedure complete message. In this case, transmission of the RRC procedure complete message is delayed to the next On Dutation period, and thus, the control plane timing performance is degraded.

Besides, the current specification also provides a Scheduling Request procedure for the UE to request the network to allocate an uplink grant when the UE has uplink data to transmit but there is no uplink grant available. However, performing the Scheduling Request procedure also causes transmission delay of the RRC procedure complete message. Detailed operation of the Scheduling Request procedure can also be found in related specifications, and is not narrated herein.

In short, when the UE receives the RRC message for configuring the DRX functionality, the DRX functionality is initiated, and the UE cannot immediately monitor the PDCCH to acquire the uplink grant allocated by the network. This, hence, causes the transmission delay of the RRC procedure complete message and reduces system efficiency of the wireless communication system.

### SUMMARY OF THE INVENTION

It is therefore an objective of the present invention to provide a method and apparatus for improving Discontinuous Reception (DRX) functionality in a user equipment (UE) of a wireless communications system, so as to avoid transmission delay of an RRC procedure complete message.

According to the present invention, a method for improving Discontinuous Reception (DRX) functionality in a user equipment (UE) of a wireless communication system is disclosed. The method includes steps of receiving a Radio Resource Control (RRC) message, the RRC message including a DRX Configuration Information Element (IE drx-Configuration); activating a DRX functionality according to the IE drx-Configuration; and starting monitoring a Physical Downlink Control Channel (PDCCH) until a PDCCH signaling addressed to the UE is received.

According to the present invention, a method for improving Discontinuous Reception (DRX) functionality in a user equipment (UE) of a wireless communication system is disclosed. The method includes steps of receiving a Radio Resource Control (RRC) message, the RRC message including a DRX Configuration Information Element (IE drx-Configuration); activating a DRX functionality according to the IE drx-Configuration; and starting a DRX Inactivity Timer of the DRX functionality to monitor a Physical Downlink Control Channel (PDCCH).

According to the present invention, a communications device for improving Discontinuous Reception (DRX) functionality in a user equipment (UE) of a wireless communication system is disclosed. The communications device includes a processor for executing a program code, and a memory, coupled to the processor, for storing the program code. The program code includes steps of receiving a Radio Resource Control (RRC) message, the RRC message including a DRX Configuration Information Element (IE drx-Configuration); activating a DRX functionality according to the IE drx-Configuration; and starting monitoring a Physical Downlink Control Channel (PDCCH) until a PDCCH signaling addressed to the UE is received.

According to the present invention, a communications device for improving Discontinuous Reception (DRX) functionality in a user equipment (UE) of a wireless communication system is disclosed. The communications device includes a processor for executing a program code, and a memory, coupled to the processor, for storing the program code. The program code includes steps of receiving a Radio Resource Control (RRC) message, the RRC message including a DRX Configuration Information Element (IE drx-Configuration); activating a DRX functionality according to the IE drx-Configuration; and starting a DRX Inactivity Timer of the DRX functionality to monitor a Physical Downlink Control Channel (PDCCH).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG.1 is a schematic diagram of a wireless communications system.

FIG. 2 is a function block diagram of a wireless communications device.

FIG. 3 is a diagram of program code of FIG. 2.

FIG. 4 is a flowchart of a process according to an embodiment of the present invention.

FIG. 5 is a flowchart of a process according to an embodiment of the present invention.

### DETAILED DESCRIPTION

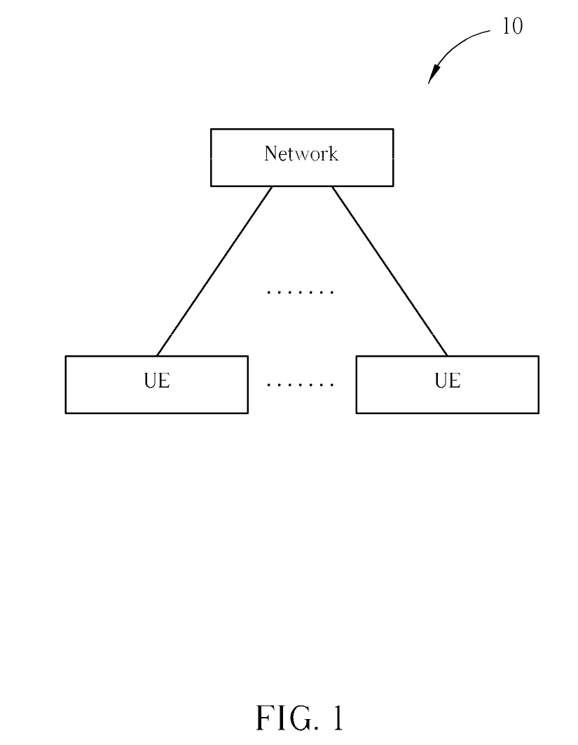

Please refer to FIG. 1, which illustrates a schematic diagram of a wireless communication system 10. The wireless communication system 10 is preferably an LTE (long-term evolution) system, and is briefly composed of a network and a plurality of UEs. In FIG. 1, the network and the UEs are simply utilized for illustrating the structure of the wireless communication system 10. Practically, the network may comprise a plurality of base stations (Node Bs), radio network controllers and so on according to actual demands, and the UEs can be devices such as mobile phones, computer systems, etc.

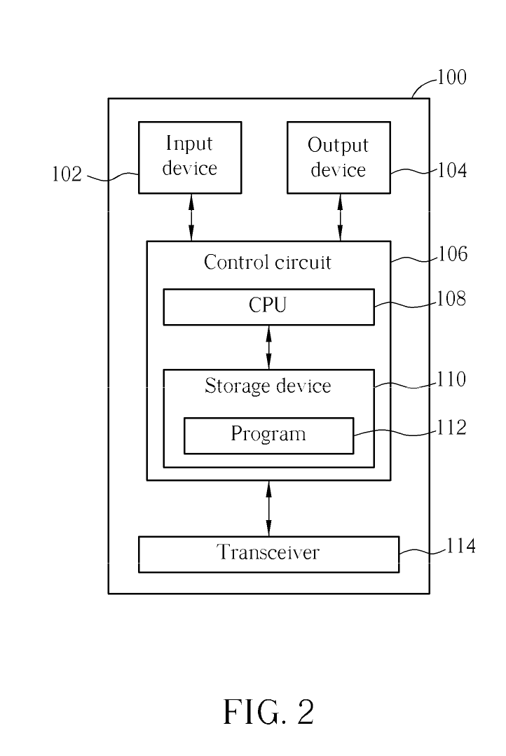

Please refer to FIG. 2, which is a functional block diagram of a communication device 100 in a wireless communication system. The communications device 100 can be utilized for realizing the UEs in FIG. 2. And the wireless communications system is preferably the LTE system. For the sake of brevity, FIG. 2 only shows an input device 102, an output device 104, a control circuit 106, a central processing unit (CPU) 108, a memory 110, a program code 112, and a transceiver 114 of the communication device 100. In the communication device 100, the control circuit 106 executes the program code 112 in the memory 110 through the CPU 108, thereby controlling an operation of the communication device 100. The communication device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communication protocol framework, the transceiver 114 can be seen as a portion of Layer 1, and the control circuit 106 can be utilized to realize functions of Layer 2 and Layer 3.

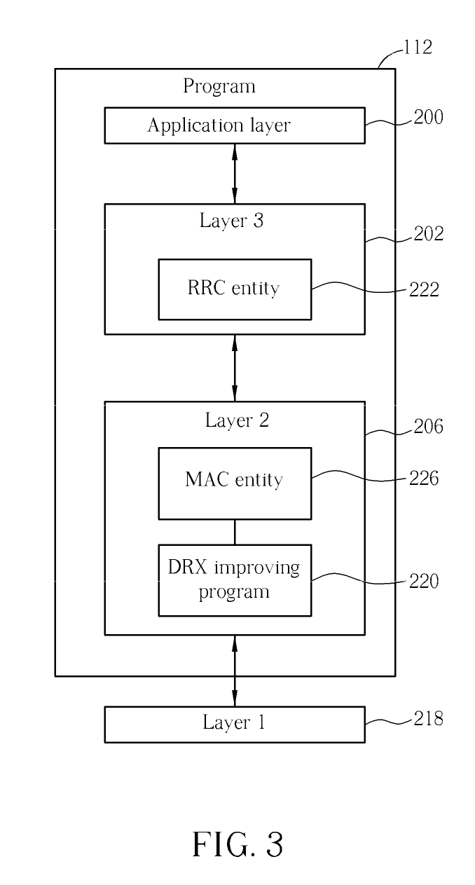

Please continue to refer to FIG. 3. FIG. 3 is a diagram of the program code 112 shown in FIG. 2. The program code 112 includes an application layer 200, a Layer 3 202, and a Layer 2 206, and is coupled to a Layer 1 218. The Layer 3 202 includes a radio resource control (RRC) entity 222 for exchanging RRC messages with other communications device, such as a NB or a radio access network, through RRC procedures and controlling the Layer 1 218 and the Layer 2 206 with the RRC messages and information elements (IEs) thereof. The Layer 2 206 includes a medium access control (MAC) entity 226 for supporting discontinuous reception (DRX) functionality. When the UE receives an RRC message including an IE drx-Configuration, the UE shall initiate the DRX functionality. In addition, the UE shall reply a RRC procedure complete message to complete a related RRC procedure accordingly. However, when the DRX functionality is initiated, the UE has to wait until a next On Duration, during which an On Dutation timer of the DRX functionality is started, to have a chance to monitor a Physical Downlink Control Channel (PDCCH), and thereby acquire an uplink grant assigned by the network or to request the network to allocate the uplink grant through a Scheduling Request procedure.

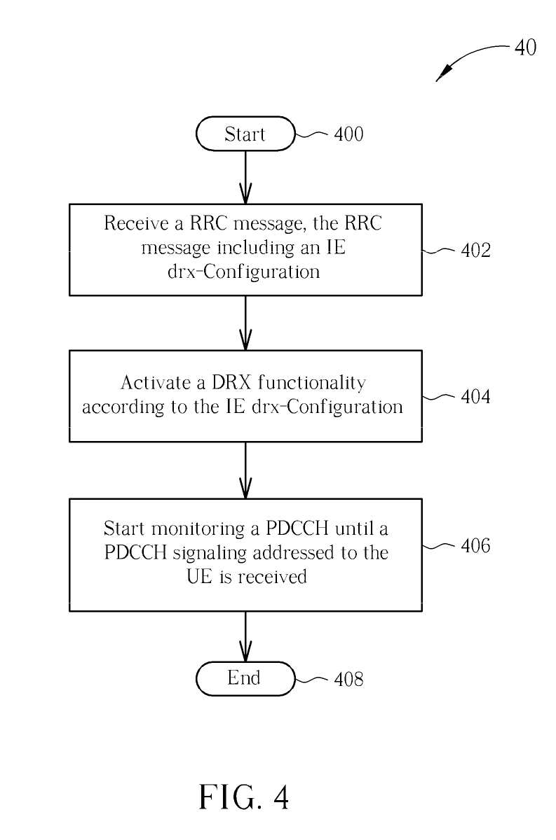

In such a situation, the embodiment of the present invention provides a DRX functionality improving program code 220 in the program code 112 to avoid transmission delay of the RRC procedure complete message. Please refer to FIG. 4, which illustrates a schematic diagram of a process 40. The process 40 is utilized for improving DRX functionality in an UE of the wireless communication system, and can be compiled into the DRX functionality improving program code 220. The process 40 includes the following steps:

Step 400: Start.

Step 402: Receive a RRC message, the RRC message including DRX Configuration Information Element (IE drx-Configuration).

Step 404: Activate a DRX functionality according to the IE drx-Configuration.

Step 406: Start monitoring a PDCCH until a PDCCH signaling addressed to the UE is received.

Step 408: End.

According to the process 40, when the UE receives the RRC message including the IE drx-Configuration, the UE activates the DRX functionality according to the IE drx-Configuration and starts monitoring the PDCCH until the PDCCH signaling addressed to the UE is received.

In the embodiment of the present invention, the above RRC message can be an RRC Connection Setup message, an RRC Connection Re-establishment message or an RRC Connection Reconfiguration message. Besides, the PDCCH signaling indicates an uplink grant assigned by the network to the UE, which is utilized for transmitting an RRC procedure complete message related to the RRC message, such as an RRC Connection Setup Complete message, an RRC Connection Re-establishment Complete message or an RRC Connection Reconfiguration Complete message, so as to complete the related RRC procedure.

Thus, when the DRX functionality is initiated due to reception of the RRC message, compared to the prior art where the UE has to wait until the next On Duration to monitor the PDCCH or to request uplink grant through the Scheduling Request procedure, the UE according to the embodiment of the present invention starts monitoring the PDCCH to allow the network allocating uplink transmission resource of the RRC procedure complete message as soon as possible. As a result, the embodiment of the present invention can improve transmission delay of the RRC procedure complete message, and therefore enhance the control plane timing performance of the wireless communication system.

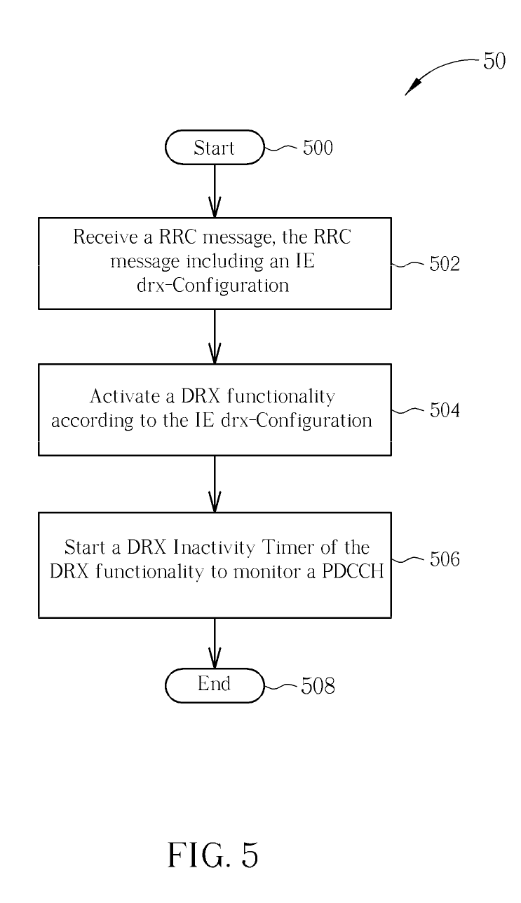

In addition, as stated in the prior art, the DRX functionality further includes a DRX Inactivity Timer for allowing the UE to monitor the PDCCH when the DRX Inactivity Timer is running. In such a situation, please refer to FIG. 5, which illustrates a schematic diagram of a process 50. The process 50 is utilized for improving DRX functionality in an UE of the wireless communication system, and can be compiled into the DRX functionality improving program code 220. The process 50 includes the following steps:

Step 500: Start.

Step 502: Receive a RRC message, the RRC message including a DRX Configuration Information Element (IE drx-Configuration).

Step 504: Activate a DRX functionality according to the IE drx-Configuration.

Step 506: Start a DRX Inactivity Timer of the DRX functionality to monitor a PDCCH.

Step 508: End.

Compared to the process 40, when the DRX functionality is initiated, the UE starts the DRX Inactivity Timer of the DRX functionality to monitor the PDCCH, so as to receive the PDCCH signaling addressed to the UE as soon as possible. As a result, the embodiment of the present invention improves the transmission delay of the RRC procedure complete message, and therefore enhances the control plane timing performance of the wireless communication system. Such variation also belongs to the scope of the present invention.

Certainly, the process 50 further includes steps of stop monitoring the PDCCH when the DRX Inactivity Timer expires if both the On Duration Timer and a DRX Retransmission Timer of the DRX functionality are not running. Such is well known by those skilled in the art, and is not narrated herein.

In summary, when the DRX functionality is configured due to reception of the RRC message, the UE according to the embodiment of the present invention starts monitoring the PDCCH to acquire uplink transmission resource of the RRC procedure complete message as soon as possible. As a result, the embodiment of the present invention can improve transmission delay of the RRC procedure complete message, and enhance the control plane timing performance of the wireless communication system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for improving Discontinuous Reception (DRX) functionality in a user equipment (UE) of a wireless communication system, the method comprising:
receiving a Radio Resource Control (RRC) message, the RRC message including a DRX Configuration Information Element (IE drx-Configuration);
activating a DRX functionality according to the IE drx-Configuration; and
starting monitoring a Physical Downlink Control Channel (PDCCH) until a PDCCH signaling addressed to the UE is received.

2. The method of claim 1, wherein the RRC message is an RRC Connection Setup message.

3. The method of claim 1, wherein the RRC message is an RRC Connection Re-establishment message.

4. The method of claim 1, wherein the RRC message is an RRC Connection Reconfiguration message.

5. The method of claim 1, wherein the PDCCH signaling indicates an uplink grant assigned by the network to the UE.

6. A method for improving Discontinuous Reception (DRX) functionality in a user equipment (UE) of a wireless communication system, the method comprising:
receiving a Radio Resource Control (RRC) message, the RRC message including a DRX Configuration Information Element (IE drx-Configuration);
activating a DRX functionality according to the IE drx-Configuration; and
starting a DRX Inactivity Timer of the DRX functionality to monitor a Physical Downlink Control Channel (PDCCH).

7. The method of claim 6, wherein the RRC message is an RRC Connection Setup message.

8. The method of claim 6, wherein the RRC message is an RRC Connection Re-establishment message.

9. The method of claim 6, wherein the RRC message is an RRC Connection Reconfiguration message.

10. The method of claim 6, wherein the UE monitors the PDCCH to receive a PDCCH signaling addressed to the UE when the DRX Inactivity Timer is running.

11. A communication device for improving Discontinuous Reception (DRX) functionality in a user equipment (UE) of a wireless communication system, the communication device comprising:
a processor for executing a program code; and
a memory, coupled to the processor, for storing the program code; wherein
the program code comprises:
receiving a Radio Resource Control (RRC) message, the RRC message including a DRX Configuration Information Element (IE drx-Configuration);
activating a DRX functionality according to the IE drx-Configuration; and
starting monitoring a Physical Downlink Control Channel (PDCCH) until a PDCCH signaling addressed to the UE is received.

12. The communication device of claim 11, wherein the RRC message is an RRC Connection Setup message.

13. The communication device of claim 11, wherein the RRC message is an RRC Connection Re-establishment message.

14. The communication device of claim 11, wherein the RRC message is an RRC Connection Reconfiguration message.

15. The communication device of claim 11, wherein the PDCCH signaling indicates an uplink grant assigned by the network to the UE.

16. A communication device for improving Discontinuous Reception (DRX) functionality in a user equipment (UE) of a wireless communication system, the communication device comprising:
a processor for executing a program code; and
a memory, coupled to the processor, for storing the program code; wherein
the program code comprises:
receiving a Radio Resource Control (RRC) message, the RRC message including a DRX Configuration Information Element (IE drx-Configuration);
activating a DRX functionality according to the IE drx-Configuration; and
starting a DRX Inactivity Timer of the DRX functionality to monitor a Physical Downlink Control Channel (PDCCH).

17. The communication device of claim 16, wherein the RRC message is an RRC Connection Setup message.

18. The communication device of claim 16, wherein the RRC message is an RRC Connection Re-establishment message.

19. The communication device of claim 16, wherein the RRC message is an RRC Connection Reconfiguration message.

20. The communication device of claim 16, wherein the UE monitors the PDCCH to receive a PDCCH signaling addressed to the UE when the DRX Inactivity Timer is running.
